(19) United States
(12) Patent Application Publication
(10) Pub. No.: US 2019/0137898 A1
(43) Pub. Date: May 9, 2019

(54) OVERCOATED PRINTED SUBSTRATE

(71) Applicant: HP Indigo B.V., Amstelveen (NL)

(72) Inventors: Daniel SKVIRSKY, Nes Ziona (IL); Inna TZOMIK, Nes Ziona (IL); Faina KOGAN, Nes Ziona (IL); Alexander STOLOV, Nes Ziona (IL)

(73) Assignee: HP Indigo B.V., Amstelveen (NL)

(21) Appl. No.: 16/307,289

(22) PCT Filed: Sep. 16, 2016
(86) PCT No.: PCT/EP2016/072022

§ 371 Date: Dec. 5, 2018

(51) Int. Cl. G03G 8/00; G03G 9/135; G03G 9/13; G03G 9/087

(52) U.S. Cl. CPC G03G 8/00; G03G 9/1355; G03G 9/08733; G03G 9/08728; G03G 9/08722; G03G 9/131

(57) ABSTRACT

Described herein is a method of providing an overcoated printed substrate. The method may comprise: providing a printed substrate comprising a primer layer disposed on a print substrate and a liquid electrostatically printed layer disposed on the primer layer; and applying a UV curable overcoat composition to the printed layer of the printed substrate, wherein the UV curable overcoat composition comprises a UV curable resin and inorganic nanoparticles dispersed therein.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition including charged toner particles in a liquid carrier can be brought into contact with the selectively charged photoconductive surface. The charged toner particles adhere to the image areas of the latent image while the background areas remain clean. The image is then transferred to a print substrate directly or, by being first transferred to an intermediate transfer member, which can be a soft swelling blanket, which is often heated to fuse the solid image and evaporate the liquid carrier, and then to the print substrate.

Overcoat varnish compositions may be applied to the printed substrate in order to protect the printed image on the substrate, for example to improve durability, e.g. scratch resistance, of the printed image.

### BRIEF DESCRIPTION OF THE FIGURES

FIG. 1 is a schematic illustration of a cross-section through an overcoated printed substrate.

### DETAILED DESCRIPTION

Before the printed substrates, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid”, “carrier,” or “carrier vehicle” refers to the fluid in which the polymer resin, pigment, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles of the resin and the pigment dispersed in a liquid carrier, which may be as described herein.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise. In some examples, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g. a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing where a liquid ink is employed in the electrostatic process rather than a powder toner. An electrostatic printing process may involve subjecting a liquid electrostatic ink to an electric field, e.g. an electric field having a field strength of 1000 V/cm or more, in some examples 1000 V/mm or more. As used herein, “liquid electrostatically printing” is used to refer to a process in which liquid electrostatic printing process is employed to print a liquid electrostatic ink onto a print substrate.

As used herein, the term “about” is used to provide flexibility to a numerical range endpoint by providing that a given value may be a little above or a little below the endpoint. The degree of flexibility of this term can be dictated by the particular variable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless specified otherwise, wt % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In some examples the printed substrates may be printed labels. Printed labels are used on or in many types of product to display information, differentiate products and comply with regulatory requirements, such as ingredients lists, safety warnings, etc.

In light of the importance of much of the information provided on labels to both consumers and regulatory bodies, it is desirable that printed labels are sufficiently resistant to water and/or chemicals that this information remains visible under the conditions that the product is packaged, stored, transported, displayed and/or used. The present inventors have found that some existing printed labels exhibit poor water and/or chemical resistance which may make the printed labels unsuitable for some purposes, for example the labelling of bottles of, e.g. shampoo and shower gel, which are exposed to warm water, chemicals and humid environments. In particular, the present inventors have found that many existing printed substrates produced by electrostatically printing inks on to a print substrate are vulnerable to the chemical and water environments to which they may be subjected during their lifecycle. The present inventions have found that even using existing over print varnishes to protect electrostatically printed inks from their environment may not provide sufficient water and/or chemical resistance to the electrostatically printed inks for use in some applications.

The present inventors have found that examples of the methods and products described herein avoid or at least mitigate at least one of the above described difficulties. They have found that examples of the method and products described herein provide printed substrates, e.g. printed labels having improved water and/or chemical resistance.

Described herein is an overcoat varnish composition comprising a UV curable resin and inorganic nanoparticles dispersed therein.

In an aspect, the present invention provides a method of providing an overcoated printed substrate. The method may comprise:

providing a printed substrate comprising a primer layer disposed on a print substrate and a liquid electrostatically printed layer disposed on the primer layer; and

applying a UV curable overcoat composition to the printed layer of the printed substrate,

wherein the UV curable overcoat composition comprises a UV curable resin and inorganic nanoparticles dispersed therein.

In an aspect, the present invention provides an overcoated printed substrate. The overcoated printed substrate may comprise:

a print substrate;

a primer layer disposed on the print substrate;

a liquid electrostatically printed layer disposed on the primer layer disposed on the print substrate; and

an overcoat layer disposed on the printed layer,

wherein the overcoat layer comprises a UV cured resin and inorganic nanoparticles dispersed therein.

### Printed Substrate

The printed substrate which is overcoated with a UV curable overcoat composition may comprise a print substrate on which a primer layer is disposed and a liquid electrostatically printed layer disposed on the primer layer on the print substrate.

### Print Substrate

The print substrate may be any suitable substrate. The print substrate may be any suitable substrate capable of having an image printed thereon. The print substrate may include a material selected from an organic or inorganic material. The material may include a natural polymeric material, e.g. cellulose. The material may include a synthetic polymeric material, e.g. a polymer formed from alkylene monomers, including, for example, polyethylene and polypropylene, polymers such as PVC and PET and co-polymers such as styrene-polybutadiene. The polypropylene may, in some examples, be biaxial orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. In some examples, the print substrate is a transparent print substrate, for example the print substrate may be formed from a transparent material such as a transparent polymeric material, e.g. a polymer formed from alkylene monomers, including, for example, polyethylene and polypropylene, polymers such as PET and PVC, and co-polymers such as styrene-polybutadiene.

In some examples, the print substrate is a label substrate.

### Label Substrate

The label substrate may be any label substrate suitable for use in a label. The label substrate may be any suitable substrate capable of having an image printed thereon. The label substrate may comprise opposing first and second surfaces. In some examples, the second surface of the label substrate is suitable for application of an adhesive. In some examples, an adhesive layer is present on the second surface of the label substrate.

The label substrate may comprise opposing first and second surfaces. In some examples, an adhesive layer is disposed on the second surface of the label substrate. In some examples, the second surface of the label substrate is suitable for the application of an adhesive layer. In some examples, an adhesive layer is disposed on the second surface of the label substrate. In some examples, in the method, an adhesive is present on the second surface of the label substrate, or applied to the second surface of the label substrate after or prior to applying a UV curable overcoat composition to the printed layer of the printed substrate. A removable release layer may be present on the adhesive layer, e.g. to protect the adhesive layer during storage, which can be removed prior to use of the label.

The first surface of the label substrate may be the surface onto which a primer is applied to form a primer layer. The first surface of the label substrate may be or comprise any material that is suitable for the application of a primer layer.

In some examples, the label substrate may comprise a polymeric material. In some examples, the polymeric material may comprise a transparent polymeric material. In some examples, the label substrate comprises a film, for example, a thin film, of a polymeric material. In some examples, the polymeric material may comprise a polymer formed from alkylene monomers, including, for example, polyethylene and polypropylene, and co-polymers such as styrene-polybutadiene. In some examples, the polymeric material may comprise polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA) or polyethylene terephthalate (PET).

In some examples, the label substrate may be or comprise a metal, which may be in sheet form. In some examples, the label substrate may comprise a metallic foil or a metallized substrate. In some examples, the label substrate may comprise a metallized plastic film (i.e. plastic film having a metal layer thereon). In some examples, the metal may be selected from or made from, for example, aluminium (Al), silver (Ag), tin (Sn), copper (Cu), or mixtures thereof. In some examples, the label substrate may comprise an aluminium foil. In some examples, the label substrate may comprise a metallized polymeric film in the form of a polymer substrate coated on at least one surface with a layer of metal, for example, aluminium. In some examples, the label substrate comprises a metallized polymeric film in the form of a metallized BOPP film or a metallized PET film.

In some examples, the label substrate may comprise a plurality of layers of material, in some examples, a plurality of layers of film material laminated together. In some examples, the label substrate may comprise a plurality of layers of material selected from polymeric materials (e.g., polymeric materials selected from PE, LLDPE, MDPE, PP, BOPP, PET and OPA), metallic materials (e.g., metallic foils such as aluminium foil, or metallized films such as metallized-PET (met-PET), or metallized-BOPP (met-BOPP), and combinations thereof. In some examples, the label substrate comprises a plurality of layers of film of a polymeric material, such as a combination of films selected from PE, LLDPE, MDPE, PP, BOPP, PET and OPA, laminated together to form a pre-laminated label substrate. In some examples, the pre-laminated label substrate may comprise a metallic layer, such as an aluminium layer. In some examples, the pre-laminated label substrate may comprise a Paper/Alu/PE, PET/Al/PE, BOPP/met-BOPP or PET/PE laminate.

In some examples, the label substrate may comprise a thin film of material, wherein the film is 600 μm or less in thickness, for example, 250 μm or less in thickness, for example, 200 μm or less in thickness, for example, 150 μm or less in thickness, for example, 100 μm or less in thickness. In some examples, the label substrate may comprise a thin film of material, wherein the film is 15 μm or more in thickness, 20 μm or more in thickness, 30 μm or more in thickness, 40 μm or more in thickness, 50 μm or more in thickness, 60 μm or more in thickness, 70 μm or more in thickness, or 80 μm or more in thickness. In some examples, the label substrate comprises a thin film of material having a thickness in the range of about 50 μm to about 250 μm.

### Adhesive Layer

In some examples, the adhesive layer is disposed on the second surface of the label substrate. In some examples, a removable release layer may be present on the adhesive layer, which can be removed prior to use of the label.

In some examples, the adhesive layer is applied to the second surface of the label substrate before the printed label substrate is provided for the method of providing an overcoated printed substrate. In some examples, the adhesive is applied to the second surface of the label substrate before, during or after the application of the UV curable overcoat composition to the printed substrate.

In some examples, the removable release layer is applied at the same time as the adhesive layer is applied. In some examples, the removable release layer is applied immediately after the adhesive layer is applied.

In some examples, the adhesive layer is a pressure-sensitive adhesive layer, a heat-sensitive adhesive layer, a contact adhesive layer, a drying adhesive layer (that is, an adhesive that adheres on drying), a radiation-curing adhesive layer (e.g., a UV-curing adhesive layer) or a moisture-curing adhesive layer (e.g., an adhesive that cures by reacting with moisture present, for example, on a second substrate to which the label is, in use, applied or adhered, or in the air). The pressure sensitive adhesive may be a hot melt pressure sensitive adhesive, such as for example a rubber-based or acrylic-based pressure sensitive adhesive. The adhesive could be based on a rubber-based hot melt composition, a solvent rubber adhesive, a solvent acrylic adhesive, or a solvent polyurethane adhesive. The adhesive could be emulsion-based such as an emulsion acrylic adhesive.

In some examples, the label substrate, for example including the adhesive layer, has a thickness of about 600 μm or less, for example, about 250 μm or less, about 200 μm or less, about 150 μm or less, or about 100 μm or less. In some examples, the label substrate, for example including the adhesive layer, has a thickness of about 15 μm or more, about 20 μm or more, about 30 μm or more, about 40 μm or more, about 50 μm or more, about 60 μm or more, about 70 μm or more, or 80 μm or more. In some examples, the label substrate for example including the adhesive layer, has a thickness in the range of about 50 μm to about 250 μm, for example about 100 μm to about 200 μm.

### Primer Layer

The printed substrate may comprise a primer layer disposed on the print substrate on which the liquid electrostatically printed layer may be disposed. The primer layer may be formed on a print substrate by applying a primer to a print substrate, e.g. to the first surface of the label substrate. In examples in which the printed substrate is a printed label, the printed label may comprise a primer layer disposed on the first surface of the label substrate.

The primer layer may comprise a primer resin. In some examples, the primer resin may be selected from the group comprising or consisting of hydroxyl containing resins, carboxylic group containing resins, amine based polymer formulations, and combinations thereof. In some examples, a hydroxyl containing resin may be selected from polyvinyl alcohol resins, for example, polyvinyl alcohol based polyvinyl butyral formulations (such as Butvar resins from Eastman), Vinnol® (from Wacker polymers), cellulose derivative additives (from Eastman), polyester resins (such as Dynapol from Evonic) and polyurethane-based formulations with hydroxyl groups. In some examples, the carboxylic group containing resins may be selected from olefin co-acrylic or methacrylic acid based copolymers, polyacrylic acid based polymers, and polylactic acid based polymers. In some examples, the amine based polymer formulations may be selected from polyamines and polyethylene imines. The primer resin may be selected from the group comprising, or consisting of, a polyvinyl alcohol resin, cellulose based resins, a polyester, a polyamine, a polyethylene imine resin, polyamide resin, polyurethane, copolymers of an alkylene monomer and an acrylic or methacrylic acid monomer, and polyacrylic polymers.

In some examples, the primer resin comprises a carboxylic functional group, an amine functional group or a polyol functional group, or a combination thereof. In some examples, the primer resin comprises an amine functional group or a carboxylic functional group. In some examples, the primer resin comprises an amine functional group. In some examples, the primer resin comprises or consists of a polyethylene imine resin.

An example of a material suitable as a primer is Michelman DigiPrime® 050.

In some examples, primer layer has a thickness of about 1 μm or less, for example, about 0.5 μm or less, about 0.4 μm or less, or about 0.3 μm or less. In some examples, the primer layer, has a thickness of about 0.01 μm or more, about 0.05 μm or more, or about 0.1 μm or more. In some examples, primer layer has a thickness in the range of about 0.1 to about 0.3 μm.

### Liquid Electrostatically Printed Layer

Liquid electrostatic printing, is one method by which images or information can be printed onto print substrates such as label substrates. A liquid electrostatic printing process, i.e. a process by which a liquid electrostatically printed layer may be formed, generally involves creating an image on a photoconductive surface, applying a liquid electrostatic ink having charged particles to the photoconductive surface, such that they selectively bind to the image, and then transferring the charged particles in the form of the image to a print substrate, such as a label substrate.

The liquid electrostatically printed layer may comprise a layer formed by liquid electrostatically printing a liquid electrostatic ink composition to a print substrate, e.g. to a primer layer disposed on a print substrate.

In some examples, the liquid electrostatically printed layer may be provided with an ink coverage of greater than about 100%, in some examples greater than about 200%, greater than about 250%, or greater than about 300%.

The liquid electrostatic ink composition printed on the print substrate, e.g. the primer layer disposed on the print substrate, to form a printed substrate may comprise a carrier liquid and chargeable particles comprising a resin. In some examples, the liquid electrostatic inks may comprise a colourant and a thermoplastic resin dispersed in a carrier liquid. In some examples, the thermoplastic resin may comprise a copolymer of an alkylene monomer and a monomer selected from acrylic acid and methacrylic acid. In some examples, the thermoplastic resin may comprise an ethylene acrylic acid resin, an ethylene methacrylic acid resin or combinations thereof. In some examples, the electrostatic ink also comprises a charge director and/or a charge adjuvant. In some examples, the liquid electrostatic inks described herein may be ElectroInk® and any other Liquid Electro Photographic (LEP) inks (or liquid electrostatic inks) developed by Hewlett-Packard Company.

In some examples, after printing a liquid electrostatic ink composition to form a printed layer, the printed layer may comprise a reduced amount of carrier liquid compared with the liquid electrostatic ink composition used to form the printed layer. In some examples, the printed layer formed by liquid electrostatically printing a liquid electrostatic ink composition may be substantially free from carrier liquid. Substantially free from carrier liquid may indicate that the printed layer contains less than 5 wt. % carrier liquid, in some examples, less than 2 wt. % carrier liquid, in some examples, less than 1 wt. % carrier liquid, in some examples, less than 0.5 wt. % carrier liquid. In some examples, the liquid electrostatically printed layer is free from carrier liquid.

Each of these components of a liquid electrostatic ink composition, which may be the liquid electrostatically printed ink composition forming the printed layer, will be described separately in the sub-sections which follow.

### Resin

The liquid electrostatic ink composition may include chargeable particles comprising a resin. The resin may be a thermoplastic resin. A thermoplastic polymer is sometimes referred to as a thermoplastic resin. The resin may coat a colourant/pigment. In some examples, the resin coats a pigment/colorant such that particles are formed having a core of pigment/colourant and an outer layer of resin thereon. The outer layer of resin may coat the pigment/colourant partially or completely.

In some examples, the liquid electrostatic ink composition may comprise chargeable ink particles comprising a pigment and a resin.

The resin typically includes a polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the polymer is a copolymer of an alkylene monomer and a monomer having an acid side group. In some examples the alkylene monomer is an ethylene or a propylene monomer. In some examples, the monomer having an acid side group is an acrylic acid monomer or a methacrylic acid monomer. In some examples, the electrostatic ink composition comprises a polymer resin comprising a copolymer of an alkylene monomer and a monomer selected from acrylic acid and methacrylic acid.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes.

In some examples, the polymer having acid side groups has a melt flow rate of greater than about 120 g/10 minutes, in some examples greater than about 200 g/10 minutes, in some examples greater than about 300 g/10 minutes, in some examples greater than about 400 g/10 minutes. In some examples, the polymer having acid side groups has a melt flow rate of about 450 g/10 minutes.

In some examples, the polymer having acid side groups has a melt flow rate of less than about 500 g/10 minutes.

In some examples, the polymer having acid side groups has a melt flow rate in the range of about 150 g/10 minutes to about 600 g/10 minutes. In some examples, the polymer having acid side groups has a melt flow rate in the range of about 200 g/10 minutes to about 500 g/10 minutes.

In some examples, the polymer having acid side groups constitutes at least 50 wt. % of the resin, in some examples at least 60 wt. % in some examples at least 80 wt. %, in some examples at least 90 wt. %. In some examples, the polymer having acid side groups has a melt flow rate of greater than about 200 g/10 minutes, in some examples a melt flow rate of greater than about 200 g/10 minutes and up to about 500 g/10 minutes, and constitutes at least 50 wt. % of the resin, in some examples at least 60 wt. % in some examples at least 80 wt. %, in some examples at least 90 wt. %.

The melt flow rate can be measured using standard procedures, for example as described in ASTM D1238.

The acidic side groups may be in free acid form or may be in the form of an anion and associated with one or more counterions, generally metal counterions, e.g. a metal selected from the alkali metals, such as lithium, sodium and potassium, alkali earth metals, such as magnesium or calcium, and transition metals, such as zinc. The polymer having acidic sides groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and an example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In some examples, the resin essentially consists of a copolymer of ethylene and methacrylic acid. In some examples the methacrylic acid of the copolymer of ethylene and methacrylic acid constitutes about 8 wt % to about 12 wt % of the copolymer, in some examples about 9 wt % to about 11 wt % of the copolymer, in some examples about 10 wt. % of the copolymer.

In an example, the resin constitutes about 5 to 90%, in some examples about 5 to 80%, by weight of the solids of the electrostatic ink composition. In another example, the resin constitutes about 10 to 60% by weight of the solids of the electrostatic ink composition. In another example, the resin constitutes about 15 to 40% by weight of the solids of the electrostatic ink composition. In another example, the resin constitutes about 60 to 95% by weight, in some examples from 80 to 90% by weight, of the solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, for example, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel407™, Nucrel 609HS™, Nucrel 908HS™, Nucrel 1202HC™, Nucrel30707™, Nucrel1214™, Nucrel 903™, Nucrel 3990™, Nucrel910™, Nucrel925™, Nucrel699™, Nucrel599™, Nucrel960™, Nucrel RX 76™, Nucrel2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

In some examples, the colorant constitutes a certain wt %, e.g. from 1 wt %, to 60 wt % of the solids of the electrostatic ink composition, and the remaining wt % of the solids of the electrostatic ink composition is formed by the resin and, in some examples, any other additives that are present. The other additives may constitute 10 wt % or less of the solids of the electrostatic ink composition, in some examples 5 wt % or less of the solids of the electrostatic ink composition, in some examples 3 wt % or less of the solids of the electrostatic ink composition. In some examples, the resin may constitute 5% to 99% by weight of the solids in the electrostatic ink composition, in some examples 50% to 90% by weight of the solids of the electrostatic ink composition, in some examples 70% to 90% by weight of the solids of the electrostatic ink composition. The remaining wt % of the solids in the ink composition may be a colorant and, in some examples, any other additives that may be present.

### Colorant

The liquid electrostatic ink composition may comprise a colorant. The colorant may be a dye or a pigment. The colorant can be any colorant compatible with the liquid carrier and useful for electrophotographic printing. For example, the colorant may be present as pigment particles or may comprise a resin (in addition to the resins described herein) and a pigment. The resins and pigments can be any of those standardly used. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. In some examples, the pigment may be a white pigment. Where the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment.

The colorant or pigment particle may be present in the LEP ink composition in an amount of from 10 wt % to 80 wt % of the total amount of resin and pigment, in some examples 15 wt % to 80 wt %, in some examples 15 wt % to 60 wt %, in some examples 15 wt % to 50 wt %, in some examples 15 wt % to 40 wt %, in some examples 15 wt % to 30 wt % of the total amount of resin and colorant. In some examples, the colorant or pigment particle may be present in the LEP ink in an amount of at least 50 wt % of the total amount of resin and colorant or pigment, for example at least 55 wt % of the total amount of resin and colorant or pigment.

### Carrier Liquid

The liquid electrostatic ink composition includes a liquid carrier. In some examples, the liquid electrostatic ink composition comprises chargeable particles including the resin which may be dispersed in the liquid carrier. The liquid carrier can include or be a hydrocarbon, silicone oil, vegetable oil, etc. The liquid carrier can include, for example, an insulating, non-polar, non-aqueous liquid that can be used as a medium for ink particles, i.e. the ink particles including the resin and, in some examples, a pigment. The liquid carrier can include compounds that have a resistivity in excess of about 10⁹ ohm·cm. The liquid carrier may have a dielectric constant below about 5, in some examples below about 3. The liquid carrier can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carriers include, for example, aliphatic hydrocarbons, isoparaffinic compounds, paraffinic compounds, dearomatized hydrocarbon compounds, and the like. In particular, the liquid carriers can include, for example, Isopar-G™, Isopar-H™, Isopar-L™, Isopar-M™, Isopar-K™, Isopar-V™, Norpar12™, Norpar13™, Norpar15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The liquid electrostatic ink composition, when printed on a print substrate, for example to form a liquid electrostatically printed layer, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt % liquid carrier, in some examples, less than 2 wt % liquid carrier, in some examples less than 1 wt % liquid carrier, in some examples less than 0.5 wt % liquid carrier. In some examples, the ink printed on the print substrate is free from liquid carrier.

### Charge Director

In some examples, the liquid electrostatic ink composition includes a charge director. The charge director may be added to an electrostatic ink composition in order to impart and/or maintain sufficient electrostatic charge on the chargeable resin particles or ink particles. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

The charge director may be added in order to impart and/or maintain sufficient electrostatic charge on the chargeable resin particles or ink particles, which may be particles comprising the thermoplastic resin.

In some examples, the electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al⁺³, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃⁻) C(O)—O—R²], wherein each of R¹ and R² is an alkyl group. In some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director is present in an amount of from 3 mg/g to 20 mg/g, in some examples from 3 mg/g to 15 mg/g, in some examples from 10 mg/g to 15 mg/g, in some examples from 5 mg/g to 10 mg/g (where mg/g indicates mg per gram of solids of the liquid electrostatic ink composition).

### Other Additives

The liquid electrostatic ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

In some examples, the electrostatic ink composition includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate. In some examples, the charge adjuvant is VCA (an aluminium stearate available from Sigma Aldrich).

The charge adjuvant may be present in an amount of about 0.1 to 5% by weight, in some examples about 0.1 to 1% by weight, in some examples about 0.3 to 0.8% by weight of the solids of the electrostatic ink composition, in some examples about 1 wt % to 3 wt % of the solids of the electrostatic ink composition, in some examples about 1.5 wt % to 2.5 wt % of the solids of the electrostatic ink composition.

The charge adjuvant may be present in an amount of less than 5.0% by weight of total solids of the electrostatic ink composition, in some examples in an amount of less than 4.5% by weight, in some examples in an amount of less than 4.0% by weight, in some examples in an amount of less than 3.5% by weight, in some examples in an amount of less than 3.0% by weight, in some examples in an amount of less than 2.5% by weight, in some examples about 2.0% or less by weight of the solids of the electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C₈ to C₂₈ fatty acid anion, in some examples a C₁₄ to C₂₂ fatty acid anion, in some examples a Cm to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt % to 5 wt % of the solids of the electrostatic ink composition, in some examples in an amount of 0.1 wt % to 2 wt % of the solids of the electrostatic ink composition, in some examples in an amount of 0.1 wt % to 2 wt % of the solids of the electrostatic ink composition, in some examples in an amount of 0.3 wt % to 1.5 wt % of the solids of the electrostatic ink composition, in some examples about 0.5 wt % to 1.2 wt % of the solids of the electrostatic ink composition, in some examples about 0.8 wt % to 1 wt % of the solids of the electrostatic ink composition, in some examples about 1 wt % to 3 wt % of the solids of the electrostatic ink composition, in some examples about 1.5 wt % to 2.5 wt % of the solids of the electrostatic ink composition.

In some examples, printed layer has a thickness of about 10 μm or less, for example, about 5 μm or less, about 4 μm or less, about 3 μm or less, about 2 μm or less, or about 1 μm. In some examples, the printed layer, has a thickness of about 0.1 μm or more, about 0.5 μm or more, about 1 μm, or about 1 μm or more. In some examples, the printed layer has a thickness in the range of about 0.5 to about 5 μm.

### UV Curable Overcoat Composition

The UV curable overcoat composition comprises a UV curable resin and inorganic nanoparticles dispersed therein. The UV curable overcoat composition may be cured on exposure to UV radiation to form an overcoat layer. The overcoat layer comprises a UV cured resin and inorganic nanoparticles dispersed therein.

In some examples, the UV curable overcoat composition may further comprise a photo initiator. A photo-initiator, or UV initiator, is an agent that initiates a reaction upon exposure to UV light to cure the composition, as described herein, after its application to a printed substrate by cross-linking the UV curable resin. In some examples, the photo-initiator is a cationic photo-initiator or a radical photo-initiator. The photo-initiator may be a single compound or a mixture of two or more compounds. It may be present in the composition in an amount sufficient to cure the UV curable overcoat composition. In some examples, the photo-initiator is present in the composition in an amount representing from about 0.01 to about 10 wt %, or from about 1 to about 5 wt %. In one example the photo-initiator may be present in an amount of less than about 5 wt %, for example less than about 4 wt %, less than about 3 wt %, less than about 2 wt %, less than about 1 wt %.

In some examples, the overcoat layer has a thickness of about 10 μm or less, for example, about 5 μm or less, or about 4 μm or less. In some examples, the overcoat layer, has a thickness of about 0.5 μm or more, about 1 μm or more, or about 2 μm or more. In some examples, the overcoat layer has a thickness in the range of about 2 to about 4 μm.

In some example, the UV curable overcoat composition and or the cured overcoat layer is transparent and/or colourless.

The UV curable overcoat composition and or the cured overcoat layer may be colourless such that they may be used as overcoating compositions, e.g. varnishes, for example in the methods described herein without contributing a further subtractive effect on the CMYK inks that would substantially affect the colour of an underprinted colored image (e.g. the printed layer).

The term “transparent” herein may be used to describe a composition that allows light to pass there through. In the context of a UV curable overcoat composition and or the cured overcoat layer, the term “transparent” may mean that the composition allows light to pass through it such that, when the UV curable overcoat composition is applied over a printed image of at a thickness of 5 μm or less, for instance, 1 to 5 μm (e.g. 2-4 μm), the printed image is visible to the naked eye. In some examples, the UV curable overcoat composition/cured overcoat layer is transparent, whereby, when the UV curable overcoat composition is applied to a printed layer with a thickness of 2-4 μm, or the cured overcoat layer has a thickness of 2-4 μm, the change in optical density of the image provide by the printed layer is within ±0.1, or ±0.05 of the optical density of the un-coated image. Additionally or alternatively, the UV curable overcoat composition/cured overcoat layer is transparent, whereby, when the UV curable overcoat composition is applied to a printed layer with a thickness of 2-4 μm, or the cured overcoat layer has a thickness of 2-4 μm, the colours in the coated image of the overcoated printed substrate are substantially the same as the colours in the uncoated image of the printed substrate. In some examples, the difference in the colour(s) of the overcoated and un-coated images are small. Reference is made to ASTM D1729-96 (Reapproved 2009, which specifies the equipment and procedures for visual appraisal of colours and colour differences of opaque materials that are diffusely illuminated. In some examples, the delta E (determined according to CIE94) between the colours of the varnished and un-varnished image may be 3 or less, for example, 2 or less. In some examples, the delta E (determined according to CIE94) may be 1.5 or less, for example, 1 or less.

### UV Curable Resin

The UV curable resin may comprise any resin or combinations of resins which may be cured, e.g. crosslinked, on exposure to UV radiation. In some examples, the UV curable resin may comprise any resin or combinations of resins which may be cured in the presence of a photo-initiator, e.g. crosslinked, on exposure to UV radiation. In some examples the UV curable resin may comprise a mixture of monomers and/or oligomers which may be cross-linked on exposure to UV radiation, for example in the presence of a photo initiator.

In some examples, the UV curable resin comprises epoxide-containing molecules (i.e. molecules comprising —CR¹(O)CR²— groups, in some examples R¹ and R² may be hydrogen), vinyl terminated molecules (i.e. molecules comprising a —CH═CH₂ group, such as acrylates or styrene), or combinations thereof.

In some examples, the UV curable resin comprises vinyl terminated molecules (such as acrylates or styrene). In some examples, the UV curable resin comprises acrylates and other vinyl terminated molecules (such as styrene). In some examples, the UV curable resin comprises acrylates and styrene.

In some examples, the UV curable overcoat composition may comprise vinyl terminated molecules (e.g. acrylate molecules and styrene molecules) and a radical photo-initiator. In some examples, acrylate molecules are molecules comprising the group CH₂═CHCOO—.

In some examples, the UV curable resin comprises epoxide-containing molecules, e.g. cycloaliphatic epoxy resins. In some examples, the UV curable overcoat composition comprises epoxide-containing molecules and a cationic photo-initiator, e.g. cycloaliphatic epoxy resins and a Lewis acid initiator.

The UV curable overcoat composition described herein may comprise a UV curable overcoat varnish comprising a UV curable resin. The UV curable overcoat varnish may be any commercially available UV overcoat varnish such as Actega617 (available from Actega Coatings & Sealants) or Paragon L567 (available from Paragon Inks).

In some examples, the UV curable resin is present in the UV curable overcoat composition in an amount in the range of about 20 wt. % to about 99.9 wt. %, for example about 30 wt. % to about 99 wt. %, or about 40 wt. % to about 98 wt. %. In some examples, the UV curable overcoat composition contains at least about 20 wt. % of the UV curable resin, for example at least about 30 wt. %, at least about 40 wt. %, or at least about 50 wt. % of the UV curable resin.

In some examples the UV curable overcoat composition consists essentially of a UV curable resin, inorganic nanoparticles or an nanoparticle dispersion and a photo initiator.

### Inorganic Nanoparticles

The UV curable overcoat composition comprises inorganic nanoparticles. In some examples the inorganic nanoparticles may be selected from metal oxides or silica. In some examples, the inorganic nanoparticles may be selected from aluminium oxide, zinc oxide, zirconium oxide, cerium oxide, magnesium oxide, calcium oxide and titanium oxide. In some examples, the inorganic nanoparticles are aluminium oxide nanoparticles.

In some examples, the inorganic nanoparticles have a D50 particle size (e.g., based on volume of the particles) in the range of about 5 to about 200 nm, for example in the range of about 10 to about 100 nm, about 15 to about 80 nm, about 20 to about 50 nm, or about 20 to about 40 nm. In some examples, the inorganic nanoparticles have a D50 particle size (e.g., based on volume of the particles) of at least about 10 nm, for example at least about 15 nm, or at least about 20 nm. In some examples, the inorganic nanoparticles have a D50 particle size (e.g., based on volume of the particles) of up to about 200 nm, for example up to about 150 nm, up to about 100 nm, up to about 90 nm, up to about 80 nm, up to about 70 nm, up to about 60 nm, up to about 50 nm, or up to about 40 nm. The D50 particle size may be determined based on the volume of the particles using an apparatus available from Malvern instruments. The particle size may be determine using dynamic light scattering. In some examples, the particle size is determined as the largest dimension of a particle.

In some examples, the inorganic nanoparticles may be provided in a nanoparticle dispersion. In some examples, the nanoparticle dispersion may comprise a nanoparticle carrier liquid and inorganic nanoparticles.

In some examples, the nanoparticle carrier liquid may comprise a polar solvent such as a hydrocarbon polar solvent or an aqueous solvent, in some examples the nanoparticle carrier liquid may be selected from an alcohol, an acrylate or water.

In some examples, the nanoparticle dispersion may contain at least about 20 wt. % inorganic nanoparticles by total weight of the nanoparticle dispersion, for example at least about 25 wt. %, or at least about 30 wt. % inorganic nanoparticles by total weight of the nanoparticle dispersion.

In some examples, the UV curable overcoat composition is provided by mixing a UV curable resin, for example a UV curable overcoat varnish comprising a UV curable resin, with inorganic nanoparticles or an inorganic nanoparticle dispersion. The UV curable overcoat composition may be provided by mixing the a UV curable resin, for example a UV curable overcoat varnish comprising a UV curable resin, with inorganic nanoparticles or an inorganic nanoparticle dispersion until a homogenous mixture is provided.

The UV curable overcoat composition may comprise at least about 0.1 wt. %, of the inorganic nanoparticles by total weight of the composition, for example at least about 0.2 wt. %, at least about 0.3 wt. %, at least about 0.4 wt. %, at least about 0.5 wt. %, at least about 0.6 wt. %, at least about 0.7 wt. %, at least about 0.8 wt. %, at least about 0.9 wt. %, or at least about 1 wt. %. In some examples, the UV curable overcoat composition comprises up to about 10 wt. % of the inorganic nanoparticles by total weight of the composition, for example up to about 8 wt. %, up to about 7 wt. %, up to about 6 wt. %, up to about 5 wt. % or up to about 4 wt. %. In some examples, the UV curable overcoat composition comprises from about 0.1 wt. % to about 10 wt. % of the inorganic nanoparticles by total weight of the composition, for example from about 0.2 wt. % to about 8 wt. %, or about 0.5 wt. % to about 5 wt. %.

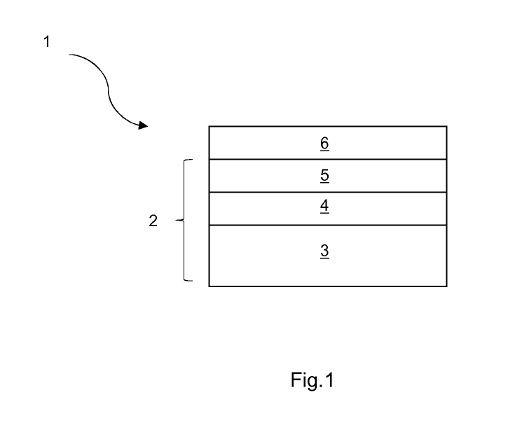

FIG. 1 shows a schematic illustration of a cross-section through an example of an overcoated printed substrate 1 as described herein and as provided by the method described herein. The overcoated printed substrate 1 comprises a printed substrate 2 and an overcoat layer 6 disposed on the printed substrate 2. The printed substrate 2 comprises a print substrate 3, for example a label substrate which may comprise an adhesive layer, a primer layer 4 disposed on the print substrate and a liquid electrostatically printed layer 5 disposed on the primer layer 4 on the print substrate 3.

### Method of Providing an Overcoated Printed Substrate

An overcoated printed substrate may be provided by applying a UV curable overcoat composition to the printed layer of the printed substrate. The UV curable overcoat composition may be applied to the printed layer of the printed substrate using any suitable method, e.g. any suitable coating process, such as gravure coating or rod coating.

In some examples, a corona treatment is applied to the printed layer of the printed substrate before the UV curable overcoat composition is applied to the printed layer.

The method may comprise curing the UV curable overcoat composition disposed on the printed substrate on exposure to UV radiation during or after the application of the UV curable overcoat composition to the printed layer of the printed substrate to provide a cured overcoat layer on the printed substrate. In some examples, curing the UV curable overcoat composition disposed on the printed substrate comprises exposing the UV curable overcoat composition to UV radiation (e.g. radiation with a wavelength in the range of about 100 nm to about 380 nm. In some examples, curing the UV curable overcoat composition disposed on the printed substrate comprises exposing the UV curable overcoat composition to UV radiation for at least about 0.1 seconds, for example at least about 0.5 seconds, at least about 1 second, or at least about 2 seconds. In some examples, the method comprises coating the printed substrate with the UV curable overcoat composition at a speed of at least about 10 m/min, for example at least about 20 m/min, or at least about 25 m/min. In some examples, the method comprises coating the printed substrate with the UV curable overcoat composition at a speed of about 25 m/min to about 30 m/min. In some examples, the method comprises coating the printed substrate with the UV curable overcoat composition and curing the UV curable overcoat composition together. In some examples, the UV curable overcoat composition is exposed to UV radiation as it is applied to the printed substrate. In some examples, the UV curable overcoat composition is cured on exposure to UV radiation having a power of greater than about 1500 W or greater than about 2000 W.

### EXAMPLES

The following illustrates examples of the methods, printed substrates and related aspects described herein. Thus, these examples should not be considered to restrict the present disclosure, but are merely in place to teach how to make examples of compositions of the present disclosure.

### Example 1

A label substrate was provided (polyethylene from Nirotech, label substrate thickness 80 μm). A primer (DiGiPrime050 from Michelman) was applied to the label substrate in-line with a liquid electrostatic printing apparatus (WE6600 press from HP Indigo) which was used to liquid electrostatically print liquid electrostatic ink compositions to provide a printed layer disposed on the primer layer on the label substrate.

A UV curable overcoat composition was prepared by mixing a UV curable overcoat varnish (Actega617, an acrylate containing composition from Actega Coatings & Sealants) with 2% (by weight of the overcoat varnish) NANOBYK-3602 (inorganic nanoparticles, aluminium oxide having a D50 particle size by volume of 40 nm dispersed in hexanediol diacrylate with a nanoparticle content of 30% by weight of the nanoparticle dispersion, from BYK Additives & Instruments).

The printed substrate was coated with a UV curable overcoat composition and the UV curable overcoat composition cured using an ABG coating system with an anilox roller (from SANDON) having 200 lines/inch. The ABG parameters were: coating speed 25 m/min, UV lamp (from GEW) output power of 2980 W and corona density 800 W. The resulting overcoated printed substrate (label) was tested for water and chemical resistance as described below. The ABG coating system was used to apply and cure the UV curable overcoat composition in one process.

### Example 2

An overcoated printed substrate was produced as for Example 1 except that the inorganic nanoparticles used were NANOBYK-3601 from BYK Additives & Instruments (aluminium oxide having a D50 particle size of 40 nm dispersed in tripropylene glycol diacrylate with a nanoparticle content of 30% by weight of the nanoparticle dispersion).

### Example 3

An overcoated printed substrate was produced as for Example 1 except that the inorganic nanoparticles used were NANOBYK-3603 from BYK Additives & Instruments (aluminium oxide having a D50 particle size of 25 nm dispersed in water with a nanoparticle content of 40% by weight of the nanoparticle dispersion).

### Example 4

An overcoated printed substrate was produced as for Example 1 except that the 2.5% of inorganic nanoparticles were mixed with the overcoat varnish and the inorganic nanoparticles used were NanoArc® AL-2460 from Nanophase (aluminium oxide having a D50 particle size of 40 nm dispersed in in tripropylene glycol diacrylate with a nanoparticle content of 30% by weight of the nanoparticle).

### Example 5

An overcoated printed substrate was produced as for Example 1 except that the 2.5% of inorganic nanoparticles were mixed with the overcoat varnish and the inorganic nanoparticles used were NanoArc® AL-2260 from Nanophase (aluminium oxide having a D50 particle size of 20 nm dispersed in in tripropylene glycol diacrylate with a nanoparticle content of 30% by weight of the nanoparticle).

### Comparative Example 6

A printed substrate was prepared as described in Example 1, no overcoat composition was applied to the printed substrate.

### Comparative Example 7

An overcoated printed substrate was produced as for Example 1 except that no inorganic nanoparticles were mixed with the UV curable overcoat varnish, i.e. the printed substrate was coated with the UV curable overcoat varnish (Actega617, from Actega Coatings & Sealants) with no inorganic nanoparticle additive.

### Example 8

An overcoated printed substrate was produced as for Example 1 except that the print substrate (label substrate) used was a polypropylene label substrate (from Nirotech, thickness 80 μm).

### Comparative Example 9

An overcoated printed substrate was produced as for Example 8 except that no inorganic nanoparticles were mixed with the UV curable overcoat varnish, i.e. the printed substrate was coated with the UV curable overcoat varnish (Actega617, from Actega Coatings & Sealants) with no inorganic nanoparticle additive.

### Example 10

An overcoated printed substrate was produced as for Example 1 except that the inorganic nanoparticles used were NanoArc® AL-2260 from Nanophase (aluminium oxide having a D50 particle size of 20 nm dispersed in in tripropylene glycol diacrylate with a nanoparticle content of 30% by weight of the nanoparticle).

### Example 11

An overcoated printed substrate was produced as for Example 1 except that the UV curable overcoat composition was prepared by mixing the inorganic nanoparticles with another acrylate containing UV curable overcoat varnish (Paragon L567 available from Paragon Inks).

### Comparative Example 12

An overcoated printed substrate was produced as for Example 11 except that no inorganic nanoparticles were mixed with the UV curable overcoat varnish, i.e. the printed substrate was coated with the UV curable overcoat varnish (Paragon L567 available from Paragon Inks) with no inorganic nanoparticle additive.

### Example 13

An overcoated printed substrate was produced as for Example 11 except that the print substrate (label substrate) used was a polypropylene label substrate (from Nirotech, thickness 80 μm).

### Comparative Example 14

An overcoated printed substrate was produced as for Example 13 except that no inorganic nanoparticles were mixed with the UV curable overcoat varnish, i.e. the printed substrate was coated with the UV curable overcoat varnish (Paragon L567 available from Paragon Inks) with no inorganic nanoparticle additive.

### Example 15

An overcoated printed substrate was produced as for Example 2 except that the print substrate (label substrate) used was a polypropylene label substrate (from Nirotech, thickness 80 μm).

### Test—Water Resistance at Room Temperature

Overcoated printed substrates prepared according to Examples and Comparative Examples 1-9 were immersed in water at room temperature for different time periods (as shown in Table 1 below). The ink coverage of each of the samples is indicated in Table 1, high coverage indicates an ink coverage of 300-360% and low ink coverage indicates an ink coverage of 100-200%. The samples were removed from the water after the time period indicated and wiped before a peeling test was conducted. The peeling test was conducted by applying an adhesive tape (3M Scotch tape 810) to the overcoat layer of each of the substrates. The tape was attached to the overcoat layer of each of the overcoated printed substrates by passing a 2 kg roller over the overcoated printed substrate on which the adhesive tape was disposed a total of 4 times. The tape was peeled off the overcoated substrate immediately after tape attachment and the peeling resistance. The peeling resistance was determined by visually inspecting the overcoated printed substrate after peeling and the adhesive tape removed from the sample, 0% peeling resistance indicates that no ink was left on the print substrate after the peeling test and 100% indicates that no ink was removed by the tape. The samples were also tested for peeling resistance before immersion in water, the peeling resistance of each of the samples before immersion in water was 100%. The results are provided in Table 1 below.

TABLE 1

| | | Peeling | Peeling results after | | |
|---|---|---|---|---|---|
| Overcoated | Ink | resistance | immersion in water | | |
| printed | Cover- | before water | Immersion time (hours) | | |
| substrate | age | resistance test | 1 | 2 | 3 |
| Ex. 1 | high | 100% | 100% | 100% | 80% |
| Ex. 2 | low | 100% | 90% | 0% | 0% |
| Ex. 2 | high | 100% | 100% | 97% | 85% |
| Ex. 3 | low | 100% | 50% | 0% | 0% |
| Ex. 3 | high | 100% | 100% | 97% | 50% |
| Ex. 4 | low | 100% | 100% | 100% | 100% |
| Ex. 4 | high | 100% | 100% | 100% | 100% |
| Ex. 5 | low | 100% | 80% | 80% | 80% |
| Ex. 5 | high | 100% | 90% | 90% | 90% |
| C. Ex. 6 | high | 100% | 0% | 0% | 0% |
| C. Ex. 7 | high | 100% | 10% | 0% | 0% |
| Ex. 8 | low | 100% | 80% | 60% | 20% |
| Ex. 8 | high | 100% | 90% | 70% | 50% |
| C. Ex. 9 | low | 100% | 50% | 0% | 0% |
| C. Ex. 9 | high | 100% | 90% | 20% | 0% |

As can be seen from the results provided in table 1, the inclusion of the nanoparticle additive in the overcoat composition surprisingly improves the water resistance of the printed labels.

### Test—Hot Water Resistance

Overcoated printed substrates prepared according to Examples and Comparative Examples 1, 2, 6, 7 and 10-13 with an ink coverage of 300-360% were immersed in hot water for 30 mins or 10 mins (as shown in Table 2 below). The samples were removed from the water after the time period indicated, cooled for 5 mins in a fridge and wiped before a peeling test was conducted. The peeling test was conducted as described for the water resistance at room temperate test described above by applying an adhesive tape (3M Scotch tape 810). The samples were also tested for peeling resistance before immersion in water, the peeling resistance of each of the samples before immersion in water was 100%. The results are provided in Table 2 below.

TABLE 2

| | Peeling results after immersion in water | | | | | |
|---|---|---|---|---|---|---|
| Overcoated | at different temperature and immersion time | | | | | |
| printed | 10 mins | | | | | 30 mins |
| substrate | 50° C. | 60° C. | 70° C. | 80° C. | 90° C. | 90° C. |
| C. Ex. 6 | 10% | 0% | 0% | 0% | 0% | 0% |
| C. Ex. 7 | 100% | 90% | 70% | 40% | 0% | 0% |
| Ex. 1 | 100% | 100% | 100% | 100% | 100% | 95% |
| Ex. 2 | 100% | 100% | 100% | 100% | 100% | 100% |
| Ex. 10 | 100% | 100% | 100% | 100% | 100% | 100% |
| C. Ex. 12 | 100% | 100% | 100% | 80% | 80% | 80% |
| Ex. 11 | 100% | 100% | 100% | 100% | 100% | 100% |
| C. Ex. 14 | 100% | 100% | 80% | 50% | 50% | 50% |
| Ex. 13 | 100% | 100% | 100 | 100% | 100% | 95% |

As can be seen from the results provided in table 2, the inclusion of the nanoparticle additive in the overcoat composition surprisingly improves the hot water resistance of the printed labels.

### Test—Chemical Resistance

Overcoated printed substrates prepared according to Examples and Comparative Examples 1, 7, 9 and 15 with an ink coverage of 300-360% were immersed in different chemical solutions for 30 mins/2 hours (as shown in Table 3 below). The samples were removed from the chemical solutions after the time period indicated and wiped before a peeling test was conducted as described above for the water resistance tests. The results are provided in Table 3 below.

TABLE 3

| | Peeling Resistance | | | | | | | | | |
|---|---|---|---|---|---|---|---|---|---|---|
| Overcoated | Immersion time: 30 mins | | | | | Immersion time: 2 hours | | | | |
| printed | | | | Buffer | Buffer | | | | Buffer | Buffer |
| substrate | MEK | Acetone | IPA | pH 4 | pH 10 | MEK | Acetone | IPA | pH 4 | pH 10 |
| C. Ex. 7 | 100% | 100% | 100% | 70% | 90% | 0% | Color | 90% | 40% | 50% |
| | | | | | | | change | | | |
| | | | | | | | 100% | | | |
| Ex. 1 | 100% | 100% | 100% | 100% | 100% | 80% | 100% | 100% | 100% | 100% |
| C. Ex. 9 | 100% | 100% | 100% | 80% | 100% | 70% | 90% | 100% | 50% | 50% |
| Ex. 15 | 100% | 100% | 100% | 100% | 100% | 100% | 100% | 100% | 80% | 100% |

As can be seen from the results provided in table 3, the inclusion of the nanoparticle additive in the overcoat composition surprisingly improves the chemical resistance of the printed labels.

While the methods, printed substrates and related aspects have been described with reference to certain examples, it will be appreciated that various modifications, changes, omissions, and substitutions can be made without departing from the spirit of the disclosure. It is intended, therefore, that the methods, printed substrates and related aspects be limited only by the scope of the following claims. Unless otherwise stated, the features of any dependent claim can be combined with the features of any of the other dependent claims, and any other independent claim.

1. A method of providing an overcoated printed substrate, the method comprising:
providing a printed substrate comprising a primer layer disposed on a print substrate and a liquid electrostatically printed layer disposed on the primer layer; and
applying a UV curable overcoat composition to the printed layer of the printed substrate,
wherein the UV curable overcoat composition comprises a UV curable resin and inorganic nanoparticles dispersed therein.

2. A method according to claim 1, wherein the inorganic nanoparticles are selected from metal oxide nanoparticles or silica nanoparticles.

3. A method according to claim 2, wherein the inorganic nanoparticles are selected from aluminium oxide, zinc oxide, zirconium oxide, cerium oxide, magnesium oxide, calcium oxide and titanium oxide nanoparticles.

4. A method according to claim 1, wherein the inorganic nanoparticles have a D50 particle size in the range of 5 to 200 nm.

5. A method according to claim 1, wherein the UV curable resin comprises vinyl-terminated molecules.

6. A method according to claim 5, wherein the UV curable overcoat composition comprises a radical photo initiator.

7. A method according to claim 5, wherein the UV curable resin comprises acrylate molecules.

8. A method according to claim 1, wherein the UV curable overcoat composition comprises 0.1 wt. % to 10 wt. % of inorganic nanoparticles by total weight of the UV curable overcoat composition.

9. A method according to claim 1 comprising curing the UV curable overcoat composition during or after application to the printed substrate.

10. A method according to claim 1, wherein the print substrate is a label substrate.

11. A method according to claim 1, wherein the UV curable overcoat composition is transparent and colourless.

12. An overcoated printed substrate comprising:
a print substrate;
a primer layer disposed on the print substrate;
a liquid electrostatically printed layer disposed on the primer layer disposed on the print substrate; and
an overcoat layer disposed on the printed layer,
wherein the overcoat layer comprises a UV cured resin and inorganic nanoparticles dispersed therein.

13. An overcoated printed substrate according to claim 12, wherein the print substrate is a label substrate.

14. An overcoated printed substrate according to claim 13, wherein the label substrate comprises opposing first and second surfaces, the primer layer being disposed on the first surface of the label substrate, and the second surface of the label substrate being suitable for application of an adhesive.

15. An overcoated printed substrate according to claim 14, wherein an adhesive layer is present on the second surface of the label substrate.
